(19) United States
(12) Patent Application Publication
(10) Pub. No.: US 2006/0028461 A1
(43) Pub. Date: Feb. 9, 2006

(54) Shift register and display panel utilizing same

(76) Inventor: Shi-Hsiang Lu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/972,811

(22) Filed: Oct. 25, 2004

(30) Foreign Application Priority Data
Aug. 5, 2004 (TW) 93123470

(51) Int. Cl. G09G 5/00

(52) U.S. Cl. 345/204

(57) ABSTRACT

A shift register having a plurality of cascaded shift register stages. The shift register is controlled by a first and a second clock signal being out of phase. Each shift register stage includes an input unit, an output unit, and a control unit. The input unit outputs a first signal according to the first clock signal. The output unit outputs an output signal according to the first signal. The control unit is coupled to the input and output units and controls the output unit according to the first and output signals, thereby stabilizing the state of the output signal.

### BACKGROUND

The present invention relates to a shift register, and in particular to a shift register employed in a display panel.

FIG. 1 is a schematic diagram of a conventional liquid crystal display panel (hereinafter referred to as “LCD panel”). As shown in FIG. 1, a LCD panel 1 comprises display array 10, a data driver 11, and a scan driver 12. The display array 10 comprises a plurality of pixels. The data driver 11 controls a plurality of data lines D₁ to Dₙ and the scan driver 12 controls a plurality of scan lines S₁ to Sₘ. The scan driver 12 sequentially outputs scan signals to scan lines S₁ to Sₘ according to a scan control signal to turn on the pixels corresponding to a row. When all the pixels corresponding to a row are turned on, data driver 11 outputs corresponding video signals with gray scale values to n pixels corresponding to the row through the data lines D₁ to Dₙ. Each data driver 11 and scan driver 12 requires a shift register to sequentially output signals.

Typically, a shift register comprises a plurality of identical, substantially cascaded, shift register stages. For example, in a shift register in a scan driver, an output signal of each shift register stage is transmitted to a next shift register stage as its input signal and to the pixels corresponding to a row through a scan line.

FIG. 2 shows a conventional shift register described in U.S. Pat. No. 4,084,106. The shift register 2 comprises two identical, substantially cascaded, shift register stages 2₁ and 2₂. Clock signals CK and XCK are provided to the shift register stages 2₁ and 2₂. The clock signals CK and XCK are out of phase. Each shift register stage comprises input and output terminals, transistors T21 to T26, and capacitors C21 and C22. The output terminal OUT₁ of the shift register stage 2₁ is coupled to the input terminal IN₂ of the shift register stage 2₂. Referring to FIGS. 2 and 3, the shift register stage 2₁ is given as an example. During a high level input signal IS₁, when the clock signals XCK and CK are at a high level and a low level respectively, the output terminal OUT₁ outputs a low level output signal OS₁ to the input terminal IN₂ as an input signal IS₂. Next, the input signal IS₁ is transformed to low level. The clock signals XCK and CK are transformed to low level and high level respectively and the output terminal OUT₁ outputs a high level output signal OS₁, thereby shifting the input signal IS₁.

Afterward, the input signal IS₁ remains at low level and preferably the output signal OS₁ is transformed to and remains at low level. When the clock signals XCK and CK are transformed to high level and low level respectively, a node N21 is at low level to turn off the transistor T22. The transistor T21 is turned on due to the clock signal XCK at high level. Thus, the output signal OS₁ is transformed to low level. When clock signals XCK and CK are transformed to low and high levels respectively, the transistor T23 is turned off. It cannot be ensured, however, that the node N21 is at low level to turn off the transistor T22 continuously. For example, if the transistor T22 operates in the subthreshold region to generate subthreshold current, the output signal OS₁ does not continuously remain at low level, resulting in false operation of the shift register stages 2₂. Thus, the timing of the shift register 2 is in error.

### SUMMARY

Accordingly, an embodiment of the invention provides a shift register. According to one embodiment of the present invention, a shift register comprises a plurality of identical, substantially cascaded, shift register stages controlled by a first clock signal and a second clock signal being out of phase. Each shift register stage receives an input signal via an input terminal and outputs an output signal from an output terminal to serve as an input signal of the next shift register.

Each shift register stage comprises an input unit, an output unit, and a control unit. The input unit coupled to the input terminal receives the input signal and outputs a first signal according to the first clock signal. The output unit coupled to the input unit and the output terminal outputs the output signal according to the fist signal. The control unit coupled to the input unit and the output unit controls the output unit according the first signal and the output signal, thereby stabilizing the state of the output signal.

### DESCRIPTION OF THE DRAWINGS

Various aspects of the invention can be more fully understood by reading the subsequent detailed description and examples with references made to the accompanying drawings, wherein:

FIG. 1 is a schematic diagram of a conventional liquid crystal display panel;

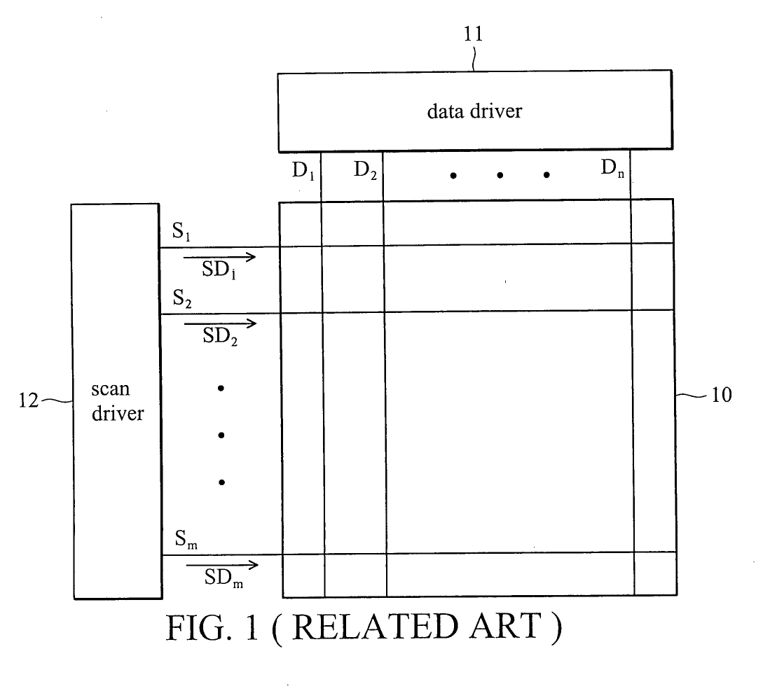

FIG. 2 shows a conventional shift register;

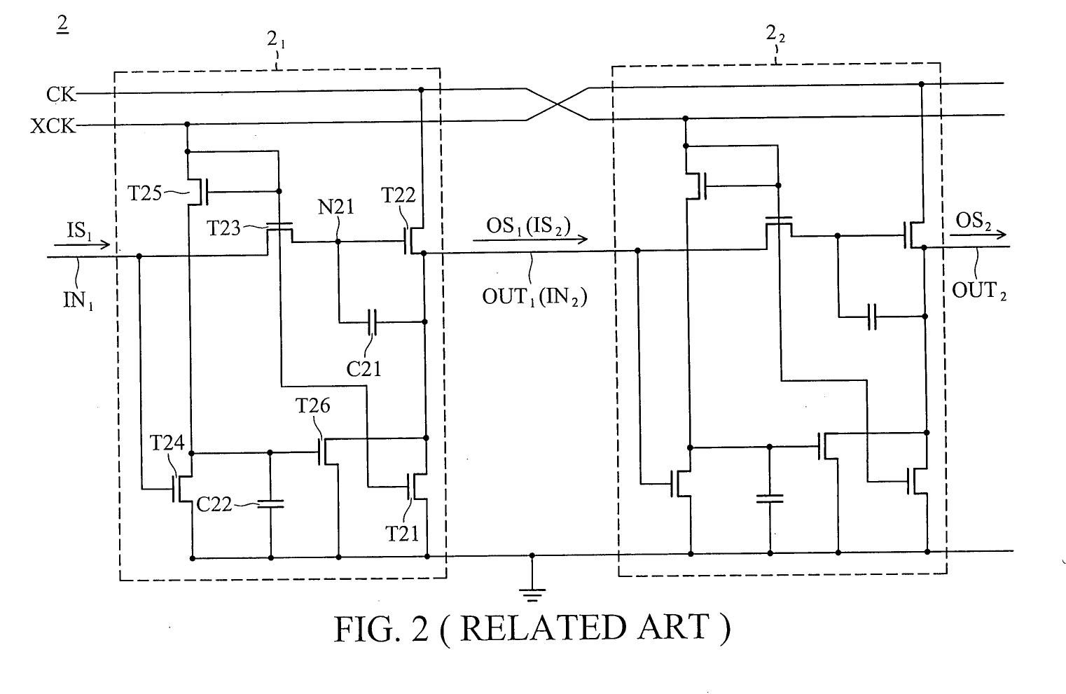

FIG. 3 is an operation timing chart of the conventional shift register of FIG. 2;

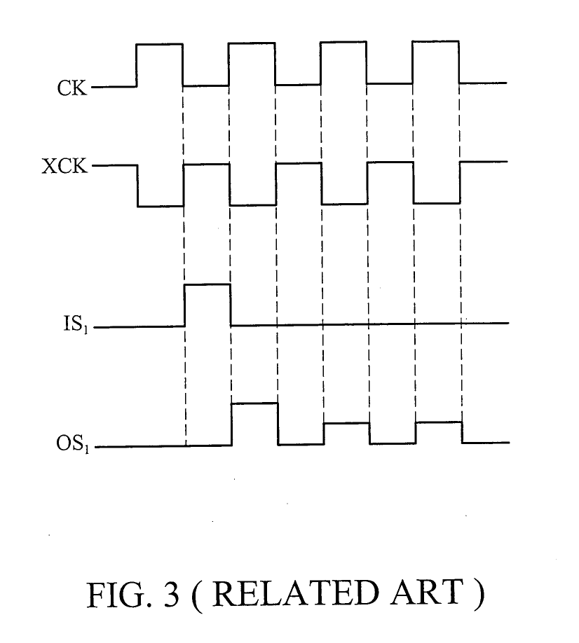

FIG. 4 shows an embodiment of a shift register;

FIG. 5 is an operation timing chart of an embodiment of a shift register of FIG. 4; and

FIG. 6 shows a display panel incorporating a shift register according to one embodiment of the present invention.

### DETAILED DESCRIPTION

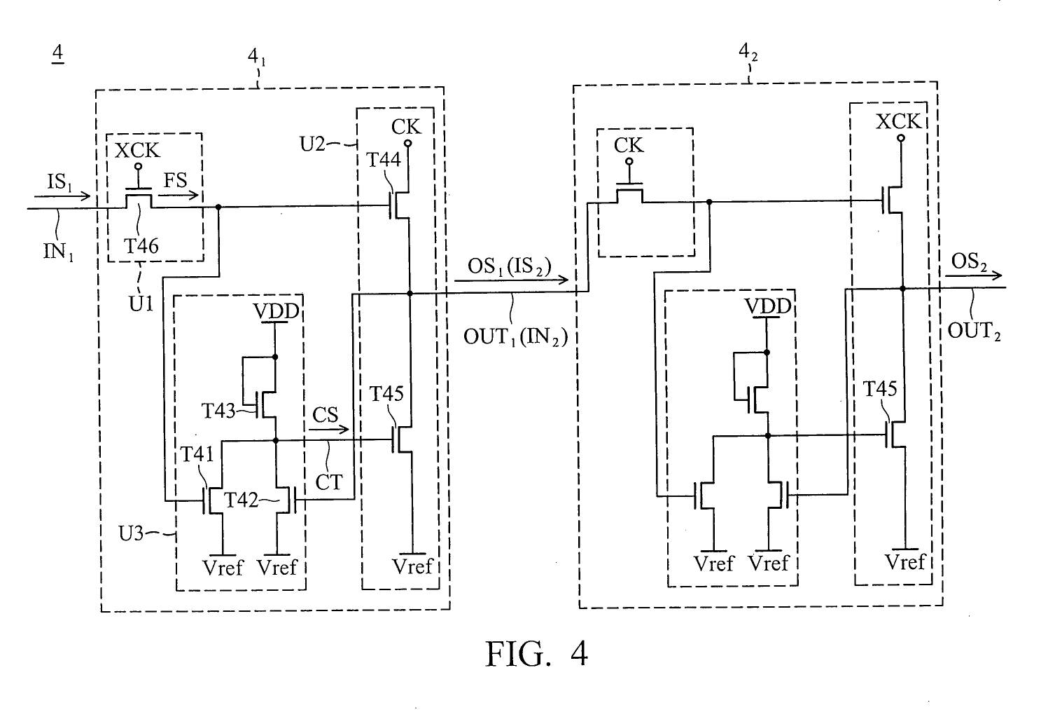

A shift register is provided. Some embodiments of a shift register comprise a plurality of identical, substantially cascaded, shift register stages and is controlled by clock signals CK and XCK being out of phase. FIG. 4 shows an embodiment of a shift register. The following description discloses a shift register 4 comprising shift register stages 4₁ and 4₂. An output terminal OUT₁ of the shift register stage 4₁ is coupled to an input terminal IN₂ of the shift register stage 4₂. Each shift register stage comprises an input unit, an output unit, and a control unit. For example, the shift register stage 4₁ can comprise an input unit U1, an output unit U2, and a control unit U3.

The input unit U1 comprises a transistor T46. The transistor T46 comprises a gate receiving the clock signal XCK, a drain coupled to the input terminal IN₁, and a source.

The output unit U2 comprises transistors T44 and T45. The transistor T44 comprises a gate coupled to the source of the transistor T46, a drain receiving the clock signal CK, and source coupled to the output terminal OUT₁. The transistor T45 comprises a gate coupled to a control terminal CT of the control unit U3, a drain coupled to the output terminal OUT₁, and a source coupled to a reference voltage source Vref.

The control unit U3 comprises transistors T41 to T43. The transistor T41 comprises a gate coupled to the source of the transistor T46, a drain coupled to the control terminal CT, and a source coupled to the reference voltage source Vref. The transistor T42 comprises a gate coupled to the output terminal OUT₁, a drain coupled to the control terminal CT, and a source coupled to the reference voltage source Vref. The transistor T43 comprises a gate and a drain both coupled to a voltage source VDD, and a source coupled to the control terminal CT. In some embodiments, the transistor T43 is continuously turned on. The reference voltage source Vref provides voltage with low level and the voltage source VDD provides voltage with high level.

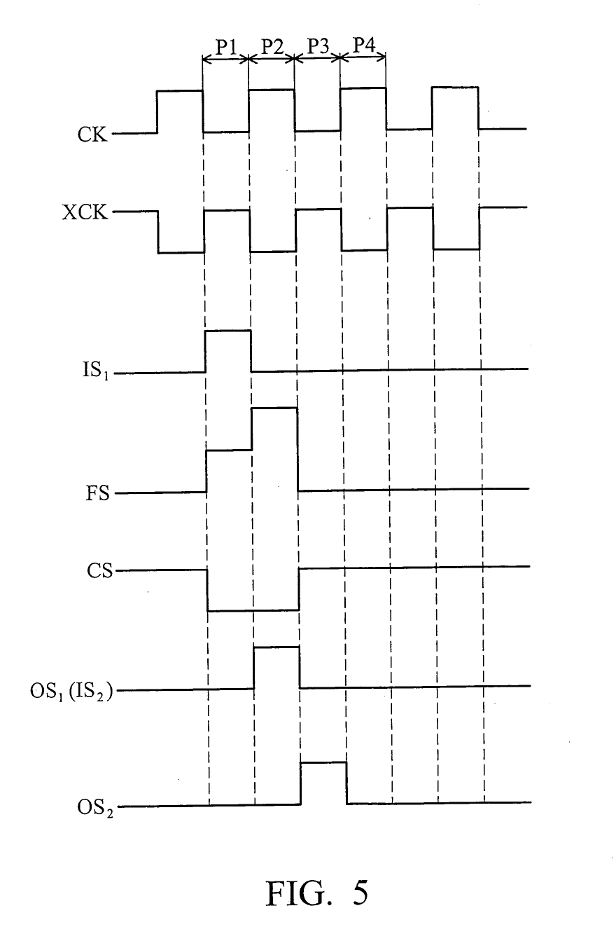

FIG. 5 is an operation timing chart of the shift register of FIG. 4. The entire duration of shifting an input signal IS₁ by the shift register stage 4₁ comprises periods P1 to P4.

During the period P1, the input signal IS₁ and the clock signal XCK are at high level. The transistor T46 is turned on and outputs a first signal FS at high level from its source. The transistor T41 is turned on by the first signal FS, so that, the control terminal CT outputs a control signal CS at low level. The transistor T45 is turned off by the control signal CS. The transistor T44 is turned on by the first signal FS. Thus, the output terminal OUT₁ outputs the output signal OS₁ at low level to serve as the input signal IN₂ of the shift register stage 4₂.

During the period P2, the input signal IS₁ and the clock signal XCK are transformed to low level. The transistor T46 is turned off. A level of the first signal FS becomes higher and remains at high level due to the coupling of a parasitic capacitor of the transistor T44. The transistors T44 and T45 are turned on and turned off respectively. Thus, the output terminal OUT₁ outputs the output signal OS₁ at high level for shifting the input signal IS₁.

During the period P3, the input signal IS₁ remains at low level and the clock signal XCK is transformed to high level. The first signal FS is transformed to low level to turn off the transistor T41 and T44. The control signal CS is transformed to high level to turn on the transistor T45. Thus, the output terminal OUT₁ outputs the output signal OS₁ at low level. At the same time, because the transistor T42 is turned off by the output signal OS₁, the control signal CS can remain at high level to turn on the transistor T45. The output signal OS₁ can continuously remain at low level during the period P3.

During the period P4, the input signal IS₁ still remains at low level and the clock signal XCK is transformed to low level. Because the transistor T46 is turned off, it cannot be ensured that the first signal FS remains at low level. The transistor T44 may operate in the subthreshold region and generate subthreshold current, so that, the output signal OS₁ cannot remain at low level. In some embodiments, the transistor T43 is turned on continuously and the control signal CS is at high level to turn on the transistor T45. Thus, the output signal OS₁ continues at low level during the period P4. Moreover, because the output signal OS₁ is further provided to the gate of the transistor T42 to turn off the transistor T42, it ensures that the control signal CS remains at high level.

In the shift register stage 4₁, according the clock signals CK and XCK, the input unit U1 receives the input signal IS₁ at high level during the period P1 and the output unit U2 then outputs the output signal OS₁ at high level during the period P2. The control unit U3 controls the output unit U2 to maintain the output signal OS₁ at low level during the periods P1, P3, and P4. Compared with conventional shift registers, each shift register stage can output a stable output signal particularly when the shift register stage completes shifting an input signal and the input signal remains at low level. Thus, the output signal of each shift register stage is not affected by subthreshold current.

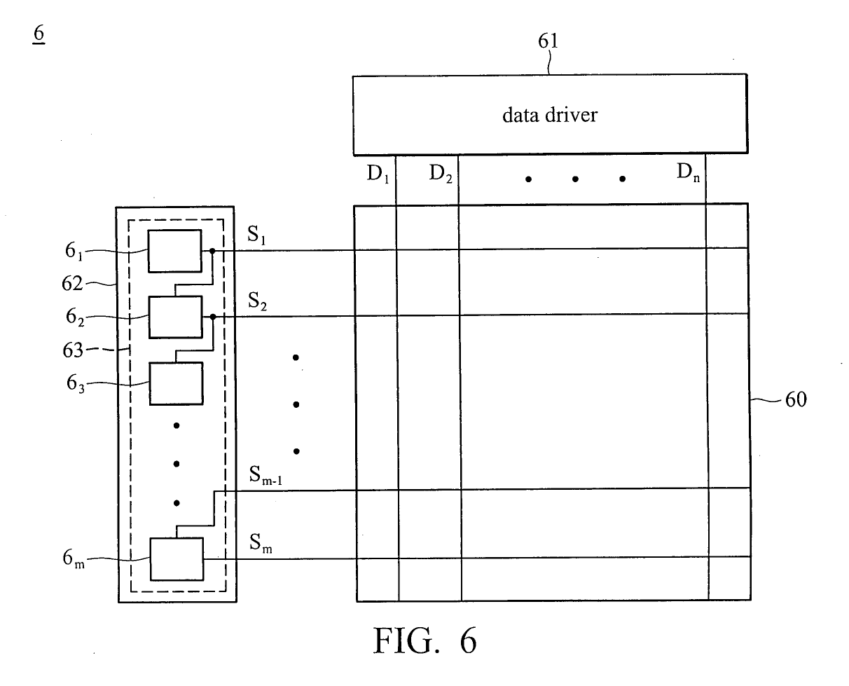

Some embodiments of a shift register can be applied in a data driver or scan driver within a display panel as shown in FIG. 6, such as a data driver 61 and scan driver 62 within a display panel 6. The display panel 6 further comprises a display array 60 defined by a plurality scan lines S₁ to Sₘ and a plurality of data lines D₁ to Dₘ. For example, an embodiment of a shift register 63 is applied in the scan driver 62. The shift register 63 comprises a plurality of shift register stages 6₁ to 6ₘ, each having the same circuitry as shown in FIG. 4. An output signal of each shift register stage is provided not only to a next shift register stage but also to a corresponding scan line.

The types of transistors and the number of shift register stages can be determined according to system requirements, without limitation. Additionally, the reference voltage source can be a ground.

Finally, while the invention has been described by way of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A shift register, comprising a plurality of identical, substantially cascaded, shift register stages controlled by a first clock signal and a second clock signal being out of phase, each shift register stage receiving an input signal via an input terminal and outputting an output signal from an output terminal to serve as an input signal of the next shift register, each shift register stage comprising:
an input unit coupled to the input terminal, receiving the input signal, and outputting a first signal according to the first clock signal;
an output unit coupled to the input unit and the output terminal and outputting the output signal according to the fist signal; and
a control unit coupled to the input unit and the output unit and controlling the output unit according the first signal and the output signal, thereby stabilizing the state of the output signal.

2. The shift register as claimed in claim 1, wherein the control unit of each shift register stage comprises:
a first transistor having a control terminal receiving the first signal, a first terminal coupled to a reference voltage source, and a second terminal;
a second transistor having a control terminal receiving the output signal, a first terminal coupled to the reference voltage source, and a second terminal; and
a third transistor having a control terminal coupled to a voltage source, a first terminal, and a second terminal coupled to the voltage source;
wherein, the second terminal of the first transistor, the second terminal of the second transistor, and the first terminal of the third transistor are all coupled to a control output terminal of the control unit and the control output terminal outputs a control signal to the output unit, thereby stabilizing the state of the output signal.

3. The shift register as claimed in claim 2, wherein the output unit of each shift register stage comprises:
a fourth transistor having a control terminal receiving the first signal, a first terminal coupled to the output terminal, a second terminal receiving the second clock signal; and
a fifth transistor having a control terminal receiving the control signal, a first terminal coupled to the reference voltage terminal, a second terminal coupled to the output terminal.

4. The shift register as claimed in claim 2, wherein the input unit of each shift register stage comprises a fourth transistor having a control terminal receiving the first clock signal, a first terminal receiving the input signal, and a second terminal outputting the first signal.

5. A display panel comprising:
a plurality of scan lines;
a plurality of data lines;
a display array defined by the scan lines and the data lines;
a data driver coupled to the data lines;
a scan driver coupled to the scan lines; and
a shift register, disposed in the scan driver, having a plurality of identical, substantially cascaded, shift register stages controlled by a first clock signal and a second clock signal being out of phase, each shift register stage receiving an input signal via an input terminal and outputting an output signal from an output terminal to the next shift serving as an input signal thereof and to the corresponding scan line;
each shift register stage comprising:
an input unit coupled to the input terminal, receiving the input signal, and outputting a first signal according to the first clock signal;
an output unit coupled to the input unit and the output terminal and outputting the output signal according to the first signal; and
a control unit coupled to the input unit and the output unit and controlling the output unit according the first signal and the output signal, thereby stabilizing the state of the output signal.
